(19) United States
(12) Patent Application Publication
(10) Pub. No.: US 2006/0170775 A1
(43) Pub. Date: Aug. 3, 2006

(54) Test apparatus and test method using the same

(75) Inventor: Eun-seok Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/282,481

(22) Filed: Nov. 21, 2005

(30) Foreign Application Priority Data
Jan. 31, 2005 (KR) 2005-0008836

(51) Int. Cl. H04N 17/00; H04N 17/02

(52) U.S. Cl. 348/181; 348/536; 348/189

(57) ABSTRACT

A test apparatus for a display apparatus having a display part to display an image thereon, the test apparatus including a PWM signal generator to receive an external video signal, and output a PWM signal; a clock signal generator to generate a system pixel clock signal based on the PWM signal output from the PWM signal generator, and output the generated system pixel clock signal to the display part; and a controller to control the PWM signal generator to sequentially adjust the frequency of the PWM signal output from the PWM signal generator. Thus, the test apparatus and method can test whether a display apparatus normally displays an image based on an external video signal if the frequency of the external video signal is deviated from a standardized frequency within predetermined limits.

### CROSS-REFERENCE TO RELATED APPLICATIONS

This application claims priority from Korean Patent Application No. 2005-0008836, filed Jan. 31, 2005, in the Korean Intellectual Property Office, the disclosure of which is incorporated herein by reference.

### BACKGROUND OF THE INVENTION

1. Field of the Invention

The present invention relates to a test apparatus and a test method using the same, and more particularly, to a test apparatus and a test method using the same, which can test whether a display apparatus displays an image normally according to frequency variance of an external video signal.

2. Description of the Related Art

Generally, a video signal source such as a broadcasting station or the like transmits a video signal having a constant frequency to a display apparatus. The display apparatus receives the video signal having the constant frequency (hereinafter, referred to as “standardized frequency”) from the broadcasting station, a digital versatile disc (DVD) player or the like and displays an image based on the received video signal. However, when the display apparatus receives a video signal having a frequency different from the standardized frequency, it cannot display an image normally.

For example, when the broadcasting station outputs a video signal having a frequency different from the standardized frequency due to a system error thereof, a flicker phenomenon or a ghost phenomenon may occur in an image displayed on the display apparatus.

Accordingly; it is necessary to test whether the display apparatus displays an image normally when the frequency of a video signal deviates from the standardized frequency within predetermined limits.

### SUMMARY OF THE INVENTION

The present invention provides a test apparatus and a test method, which can test whether a display apparatus normally displays an image based on an external video signal when the frequency of the external video signal is deviated from a standardized frequency within predetermined limits.

According to an aspect of the present invention, there is provided a test apparatus for a display apparatus having a display part to display an image thereon, the test apparatus comprising a pulse width modulation (PWM) signal generator to receive an external video signal, and output a PWM signal; a clock signal generator to generate a system pixel clock signal based on the PWM signal output from the PWM signal generator, and output the generated system pixel clock signal to the display part; and a controller to control the PWM signal generator to sequentially adjust the frequency of the PWM signal output from the PWM signal generator.

According to an aspect of the present invention, information about the number of system pixel clocks of the system pixel clock signal output from the clock signal generator is transmitted to the PWM signal generator; and the controller adjusts the frequency of the PWM signal by adjusting a deviation between the number of pixel clocks of the external video signal input for a predetermined period and the number of system pixel clocks of the system pixel clock signal.

According to an aspect of the present invention, the test apparatus further comprises an image determiner to determine the quality of an image on the basis of a pattern displayed on the display part.

According to an aspect of the present invention, the controller adjusts the deviation within predetermined limits, and determines that the display apparatus is satisfactory when the display part displays an image normally within the predetermined limits.

According to an aspect of the present invention, the controller adjusts the deviation within limits that an image is normally displayed on the display part.

According to an aspect of the present invention, the test apparatus further comprises a memory to store deviation information at the maximum deviation according to control of the controller.

According to an aspect of the present invention, the deviation information includes frequency information, and the frequency information is calculated by the following equation

$$T = f - \frac{Bo \times f}{Bi}$$

where T is the frequency information; f is the frequency of the external video signal; Bo is the number of system pixel clocks input for predetermined period; and Bi is the number of pixel clocks of the external video signal input for predetermined period.

According to an aspect of the present invention, the controller controls the display part to display information about whether the deviation information is within the limits.

According to an aspect of the present invention, the controller adjusts the deviation within limits that an image is normally displayed on the display part.

According to an aspect of the present invention, there is provided a method of testing a display apparatus comprising a display part to display an image thereon, the method comprising inputting an external video signal; adjusting a frequency of a PWM signal in sequence; generating a system pixel clock signal on the basis of the PWM signal; and determining the quality of an image displayed on the display part.

According to an aspect of the present invention, the adjusting the frequency of the PWM signal comprises adjusting the frequency of the PWM signal by adjusting a deviation between the number of pixel clocks of the external video signal input for a predetermined period and the number of system pixel clocks of the system pixel clock signal.

According to an aspect of the present invention, the determining the quality of an image comprises determining the quality of an image on the basis of a pattern displayed on the display part.

According to an aspect of the present invention, the adjusting the frequency of the PWM signal comprises adjusting the deviation within predetermined limits.

According to an aspect of the present invention, the deviation is adjusted until an image is normally displayed on the display part.

According to an aspect of the present invention, the method further comprises storing deviation information at the maximum deviation.

According to an aspect of the present invention, the deviation information includes frequency information, and the frequency information is calculated by the following equation

$$T = f - \frac{Bo \times f}{Bi}$$

where T is the frequency information; f is the frequency of the external video signal; Bo is the number of system pixel clocks input for predetermined period; and Bi is the number of pixel clocks of the external video signal input for predetermined period.

According to an aspect of the present invention, the method further comprises displaying information about whether the deviation information is within the limits.

According to an aspect of the present invention, the method further comprises storing deviation information at the maximum deviation.

### BRIEF DESCRIPTION OF THE DRAWINGS

The above and other aspects of the present invention will become apparent and more readily appreciated from the following description of the exemplary embodiments, taken in conjunction with the accompany drawings of which:

FIG. 1 is a control block diagram of a test apparatus according to an exemplary embodiment of the present invention; and

FIG. 2 is a control flowchart of a test method according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

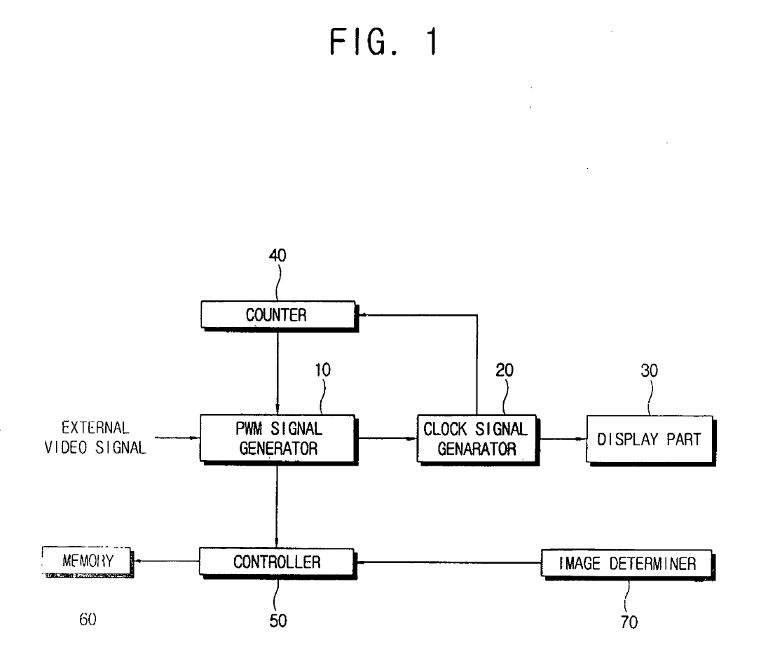

FIG. 1 is a control block diagram of a test apparatus according to an exemplary embodiment of the present invention.

A test apparatus according to an exemplary embodiment of the present invention comprises a PWM signal generator 10 to generate a PWM signal, a clock signal generator 20 to output a system pixel clock signal on the basis of the PWM signal output from the PWM signal generator 10, and a controller 50 to control the PWM signal generator 10 and the clock signal generator 20.

The PWM signal generator 10 compares a number of pixel clocks of an external video signal input during a predetermined period with that of a system pixel clock signal, that is, a number of system pixel clocks, output from the clock signal generator 20, and generates the PWM signal. When the period is one second, the PWM signal generator 10 compares the frequency of the external video signal with that of the system pixel clock signal, thereby generating the PWM signal. At this time, the external video signal may include a program clock reference (PCR) signal having data about the number of pixel clocks input during the predetermined period.

In general, the external video signal is input to the display apparatus during a predetermined standardized period. Therefore, the number of pixel clocks of the external video signal input to the PWM signal generator 10 is approximately constant. Thus, the PWM signal generator 10 adjusts the frequency of the PWM signal so as to equalize the number of system pixel clocks with the number of pixel clocks of the external video signal.

The clock signal generator 20 outputs the system pixel clock signal by changing the frequency of the PWM signal output from the PWM signal generator 10. Thus, an image is displayed on a display part 30 on the basis of the system pixel clock signal. Here, the clock signal generator 20 may comprise an oscillator to output a signal having a predetermined frequency, particularly, a voltage controlled crystal oscillator (VCXO) to generate a signal by controlling a voltage.

Further, a counter 40 is connected to the clock signal generator 20, and counts the number of system pixel clocks output from the clock signal generator 20 during the predetermined period. Then, the counter 40 outputs the counted number of system pixel clocks to the PWM signal generator 10.

The controller 50 controls the PWM signal generator 10 to adjust the frequency of the PWM signal, thereby equalizing the number of system pixel clocks with the number of pixel clocks of the external video signal. Here, the frequency of the PWM signal can be determined on the basis of a deviation between the number of system pixel clocks and the number of pixel clocks of the external video signal. However, in the test apparatus according to an exemplary embodiment of the present invention, the controller 50 adjusts the frequency of the PWM signal regardless of the deviation between the number of system pixel clocks and the number of pixel clocks of the external video signal. For example, the controller 50 forcedly adjusts the deviation between the number of system pixel clocks and the number of pixel clocks of the external video signal, thereby adjusting the frequency of the PWM signal. However, the present invention is not limited to the foregoing method as long as the controller 50 can adjust the frequency of the PWM signal.

The controller 50 adjusts the frequency of the PWM signal within predetermined limits. In the case that an image is normally displayed on the display part 30 while the controller 50 adjusts the frequency of the PWM signal within predetermined limits, a tester can determine that the display apparatus displays an image normally. On the other hand, in the case that an image is displayed with a flicker phenomenon or a ghost phenomenon, a tester can determine that the display apparatus does not display an image normally.

According to another exemplary embodiment of the present invention, the controller 50 can adjust the frequency of the PWM signal until the image is not normally displayed. At this time, the controller 50 can control the memory 60 to store information about the maximum deviation between the number of pixel clocks of the external video signal corresponding to a normally displayed image and the number of system pixel clocks, and thus a tester can determine the specification of the display apparatus on the basis of the deviation information. Here, the deviation information can include frequency information about a deviation between a conversion frequency (to be described later) and the frequency of the external video signal. The frequency information can be calculated by the following equation.

$$T = f - \frac{Bo \times f}{Bi}$$

where T is the frequency information; f is the frequency of the external video signal; Bo is the number of system pixel clocks input for the predetermined period; and Bi is the number of pixel clocks of the external video signal input for the predetermined period.

That is, Bo is the number of system pixel clocks output from the counter 40; and Bi is the number of pixel clocks extracted from the PCR signal. Here, the conversion frequency can be obtained by multiplying a ratio of the number of system pixel clocks input for a predetermined period to the number of pixel clocks extracted from the external video signal by the frequency of the external video signal. As shown in the foregoing equation, the conversion frequency is determined by the ratio of the number of pixels of the external video signal to the number of system pixel clocks. Here, the frequency information is obtained by subtracting the frequency of the external video signal from the conversion frequency.

On the basis of the foregoing deviation information, when the deviation or the frequency information is smaller than a predetermined value, it is determined that the display apparatus is defective. On the other hand, when the deviation or the frequency information is larger than a predetermined value, it is determined that the display apparatus is satisfactory.

As the controller 50 adjusts the frequency of the PWM signal in sequence, the clock signal generator 20 regards the frequency of the external video signal as the conversion frequency instead of the input frequency. That is, the conversion frequency is a virtual frequency to be regarded as the frequency of the external video signal in the clock signal generator 20 and the display part 30, which is obtained by adjusting the frequency of the PWM signal.

As described above, the controller 50 adjusts the frequency of the PWM signal and thus makes the display part 30 or the like regard the external video signal as a video signal having a frequency different from the standardized frequency.

On the basis of the deviation information, the controller 50 determines that the display apparatus is satisfactory when an image is normally displayed on the display apparatus in the state that the deviation information is within predetermined limits. Additionally, the controller 50 can control the display part 30 to display whether the display apparatus is defective.

Further, the test apparatus according to an exemplary embodiment of the present invention comprises an input part (not shown), thereby allowing a tester to input a display state of an image through the input part. For example, when an image is abnormally displayed on the display part 30, a tester can input information about that the image displayed on the display part 30 is abnormal through the input part. Then, the controller 50 stops adjusting the frequency of the PWM signal and controls the memory 60 to store the adjusted frequency therein.

According to an exemplary embodiment of the present invention, the test apparatus can comprise an image determiner 70 without the input part, thereby testing whether the display part 30 displays an image normally or abnormally. Here, the image determiner 70 employs a pattern recognition method to determine whether the state of an image is normal or abnormal, but is not limited to the pattern recognition method. On the basis of the determined results of the image determiner 70, the controller 50 can control the display part 30 to display whether an image displayed thereon is normal or abnormal.

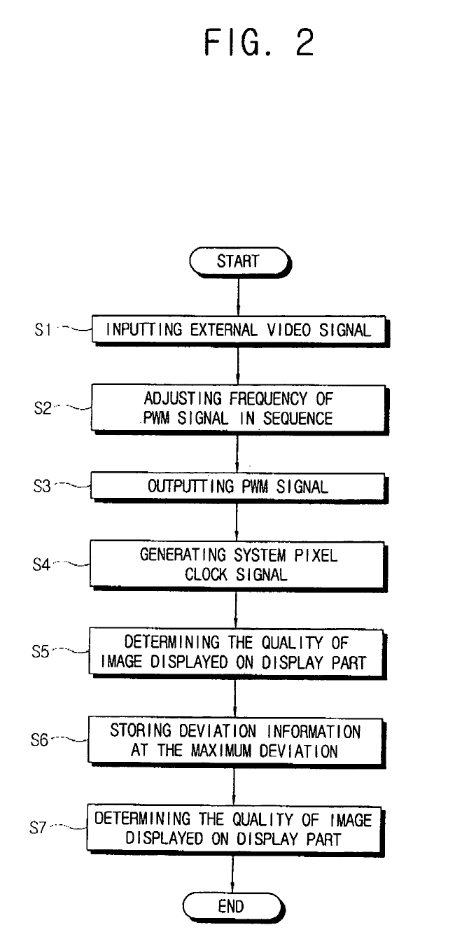

FIG. 2 is a control flowchart of a test method according to an exemplary embodiment of the present invention.

As shown in FIG. 2, when the external video signal is input at operation S1, the PWM signal generator 10 outputs the PWM signal to the clock signal generator 20. Then, the clock signal generator 20 outputs the system pixel clock signal underlying an image to be displayed on the display part 30. At this time, information about the number of system pixel clocks of the system pixel clock signal output from the counter 40 for a predetermined period is transmitted to the PWM signal generator 10. Thus, the PWM signal generator 10 generates the PWM signal on the basis of difference between the number of pixel clocks of the external video signal input for a predetermined period and the number of input system pixel clocks.

After generating the PWM signal based on the difference between the number of pixel clocks and the number of system pixel clocks, at operation S2, the controller 50 adjusts the frequency of the PWM signal regardless of the frequency of this PWM signal. At operation S3, the controller 50 adjusts the frequency of the PWM signal in sequence by forcedly adjusting the deviation between the number of feedback system pixel clocks and the number of pixel clocks of the external video signal input for a predetermined period, thereby outputting the PWM signal having the adjusted frequency to the clock signal generator 20. At operation S4, the clock signal generator 20 generates the system pixel clock signal based on the input PWM signal, and outputs the generated system pixel clock signal to the display part 30, thereby allowing the display part 30 to display an image on the basis of the system pixel clock signal.

In the case where the controller 50 adjusts the frequency of the PWM signal in sequence within predetermined limits, at operation S5, the controller 50 determines whether the display part 30 displays an image normally or abnormally. When the display part 30 displays an image normally, the controller 50 determines that the display apparatus is satisfactory. According to another exemplary embodiment of the present invention, the controller 50 may adjust the frequency of the PWM signal until it is determined that an image is not normally displayed on the display part 30. When the frequency of the PWM signal is fully adjusted, i.e., when the maximum deviation is shown between the number of pixel clocks of the external video signal and the number of system pixel clocks, at operation S6, the deviation information is stored in the memory 60. At this time, the deviation information can include the frequency information about the deviation between the foregoing conversion frequency and the frequency of the external video signal. The frequency information can be calculated by the following equation.

$$T = f - \frac{Bo \times f}{Bi}$$

In this case, according to whether the deviation information stored in the memory 60 is within predetermined limits, it is determined whether the display apparatus is defective.

At operation S7, the controller 50 controls the display part 30 to display thereon whether an image is normally displayed, or whether the display apparatus is defective.

As an image is displayed on the display part 30, a tester can determine whether the image is normal or abnormal. Alternatively, the image determiner 70 may be provided to determine the quality of an image, thereby transmitting information about the quality of the image to the controller 50.

According to an exemplary embodiment of the present invention, the test apparatus may be provided in a set-top box, or separately.

As described above, the test apparatus for the display apparatus according to an exemplary embodiment of the present invention determines the conversion frequency by adjusting the deviation between the number of pixels of external video signal and the number of system pixels. Further, the frequency information is obtained by comparing the conversion frequency with the frequency of the external video signal.

Thus, according to an exemplary embodiment of the present invention, the test apparatus for the display apparatus can test whether the display part 30 displays an image normally, until the conversion frequency is fully deviated from the standardized frequency of the external video signal within predetermined limits. Consequently, even though the display apparatus receives a video signal having a frequency different from the standardized frequency due to a broadcasting system error or the like, the display apparatus displays an image normally.

As described above, the present invention provides a test apparatus and a test method, which can test whether a display apparatus normally displays an image based on an external video signal when the frequency of the external video signal is deviated from a standardized frequency within predetermined limits.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A test apparatus for a display apparatus having a display part to display an image thereon, the test apparatus comprising:
a pulse width modulation (PWM) signal generator which receives an external video signal, and outputs a PWM signal;
a clock signal generator which generates a system pixel clock signal based on the PWM signal output from the PWM signal generator, and outputs the system pixel clock signal to the display part; and
a controller which controls the PWM signal generator to sequentially adjust a frequency of the PWM signal output from the PWM signal generator.

2. The test apparatus according to claim 1, wherein information about a number of system pixel clocks of the system pixel clock signal output from the clock signal generator is transmitted to the PWM signal generator; and
the controller adjusts the frequency of the PWM signal by adjusting a deviation between a number of pixel clocks of the external video signal input for a predetermined period and the number of system pixel clocks of the system pixel clock signal.

3. The test apparatus according to claim 2, further comprising an image determiner which determines whether a state of an image displayed on the display part is normal using a pattern recognition method.

4. The test apparatus according to claim 3, wherein the controller adjusts the deviation within predetermined limits, and determines that the display apparatus is satisfactory if the display part displays an image normally within the predetermined limits.

5. The test apparatus according to claim 3, wherein the controller adjusts the deviation within limits that an image is normally displayed on the display part.

6. The test apparatus according to claim 5, further comprising a memory which stores deviation information at a maximum deviation according to control of the controller.

7. The test apparatus according to claim 6, wherein the deviation information includes frequency information, and the frequency information is calculated by the following equation
$$T = f - \frac{Bo \times f}{Bi}$$
where T is the frequency information; f is a frequency of the external video signal; Bo is the number of system pixel clocks input for the predetermined period; and Bi is the number of pixel clocks of the external video signal input for the predetermined period.

8. The test apparatus according to claim 6, wherein the controller controls the display part to display information about whether the deviation information is within the limits.

9. The test apparatus according to claim 2, wherein the controller adjusts the deviation within predetermined limits, and determines that the display apparatus is satisfactory if the display part displays an image normally within the predetermined limits.

10. The test apparatus according to claim 2, wherein the controller adjusts the deviation within limits that an image is normally displayed on the display part.

11. The test apparatus according to claim 10, further comprising a memory to store deviation information at a maximum deviation according to control of the controller.

12. The test apparatus according to claim 11, wherein the deviation information includes frequency information, and the frequency information is calculated by the following equation
$$T = f - \frac{Bo \times f}{Bi}$$
where T is the frequency information; f is a frequency of the external video signal; Bo is the number of system pixel clocks input for the predetermined period; and Bi is the number of pixel clocks of the external video signal input for the predetermined period.

13. The test apparatus according to claim 11, wherein the controller controls the display part to display information about whether the deviation information is within the limits.

14. A method of testing a display apparatus comprising a display part to display an image thereon, the method comprising:
inputting an external video signal;
adjusting a frequency of a pulse width modulation (PWM) signal in sequence;
generating a system pixel clock signal based on the PWM signal; and
determining whether a state of an image generated based on the system pixel clock signal is normal.

15. The method according to claim 14, wherein the adjusting the frequency of the PWM signal comprises adjusting the frequency of the PWM signal by adjusting a deviation between a number of pixel clocks of the external video signal input for a predetermined period and a number of system pixel clocks of the system pixel clock signal for the predetermined period.

16. The method according to claim 15, wherein the determining the state of the image comprises determining the state of the image displayed on the display part using a pattern recognition method.

17. The method according to claim 16, wherein the adjusting the frequency of the PWM signal comprises adjusting the deviation within predetermined limits.

18. The method according to claim 16, wherein the deviation is adjusted while an image is normally displayed on the display part.

19. The method according to claim 18, further comprising storing deviation information at a maximum deviation.

20. The method according to claim 19, wherein the deviation information includes frequency information, and the frequency information is calculated by the following equation
$$T = f - \frac{Bo \times f}{Bi}$$
where T is the frequency information; f is a frequency of the external video signal; Bo is the number of system pixel clocks input for the predetermined period; and Bi is the number of pixel clocks of the external video signal input for the predetermined period.

21. The method according to claim 19, further comprising displaying information about whether the deviation information is within the limits.

22. The method according to claim 15, wherein the adjusting the frequency of the PWM signal comprises adjusting the deviation within predetermined limits.

23. The method according to claim 15, wherein the deviation is adjusted until the image is normally displayed on the display part.

24. The method according to claim 23, further comprising storing the deviation information at the maximum deviation.

25. The method according to claim 24, wherein the deviation information includes frequency information, and the frequency information is calculated by the following equation
$$T = f - \frac{Bo \times f}{Bi }$$
where T is the frequency information; f is a frequency of the external video signal; Bo is the number of system pixel clocks input for the predetermined period; and Bi is the number of pixel clocks of the external video signal input for the predetermined period.

26. The method according to claim 24, further comprising displaying information about whether the deviation information is within the limits.
